(19) United States
(12) Patent Application Publication
(10) Pub. No.: US 2007/0234000 A1
(43) Pub. Date: Oct. 4, 2007

(54) Method and system for dynamic management of a utility partition in a pre-operating system environment

(75) Inventors: Manoj Sharad Gujarathi, Round Rock, TX (US); Charles T. Perusse JR., Pflugerville, TX (US); Brent Schroeder, Austin, TX (US); Weijia Zhang, Round Rock, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/395,499

(22) Filed: Mar. 31, 2006

(51) Int. Cl. G06F 12/00

(52) U.S. Cl. 711/173

(57) ABSTRACT

An improved information handling system incorporates a primary memory resource that includes a partition. The partition includes a configuration module. In the event that the memory resource is reconfigured, the configuration module first copies or replicates the partition onto a second memory resource. Following the reconfiguration of the memory resource, the configuration module directs the restoration of the partition onto the primary memory resource.

### TECHNICAL FIELD

The present invention is related to the field of computer systems and more specifically to a method and system for dynamically managing a utility partition within an information handling system in a pre-operating system environment.

### BACKGROUND OF THE INVENTION

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Many information handling systems are shipped with a memory resource that includes a pre-configured system partition, referred to generally herein as a “partition.” A partition may also be referred to as a utility partition, an original equipment manufacturer (OEM) partition or a hidden partition. The preconfigured partition typically contains diagnostic tools for use by users and technical support personnel to diagnose and correct system problems. However, if a user reconfigures the memory resource, the partition is often written over, erased or otherwise lost. Subsequently, the desired diagnostic tools and other utilities provided in the partition are not available to diagnose and/or correct system problems. This removal of the preconfigured partition leads to user frustration as well as increased customer support and technical support costs, because the diagnostic tools that previously resided within the partition are no longer available. Additionally, because of the sometimes transitory nature of the utility partition, the utility partition is not typically used to store certain types of applications. For example, system specific drivers, updates to system specific drivers, RAID utilities and installer/loaner hot fixes are not typically stored in a utility partition.

### SUMMARY OF THE INVENTION

Therefore a need has arisen for a system and method for maintaining a partition within an information handling system.

A further need has arisen for a system and method for providing a partition with improved functionality.

The present disclosure provides an improved information handling system that includes a memory resource with a partition. The partition includes a configuration module. In the event that the memory resource is reconfigured, the configuration module first copies or replicates the partition onto a second memory resource. Following the reconfiguration of the memory resource, the configuration module directs the restoration of the partition onto the memory resource.

In one aspect, an information handling system is disclosed that includes a memory resource with a partition. One or more utility applications are stored on the partition, including a configuration module. The configuration module includes a set-up resource able to facilitate the configuration and/or reconfiguration of the memory resource. The configuration module is further able to replicate the partition onto a second memory resource associated with the information handling system, facilitate the configuration or reconfiguration of the memory resource, and restore the partition on the memory resource from the partition replicated on the second memory, following the configuration (or reconfiguration) of the memory resource.

In another aspect a configuration module for a partition stored on an information handling system memory resource is disclosed. The configuration module includes executable instructions that are able to replicate the partition onto a second memory resource associated with the information handling system. The configuration module further includes executable instruction for configuring the memory resource and restoring the partition onto the memory resource from the partition replicated on the second memory.

In yet another aspect a method for managing a partition stored on an information handling system includes providing a configuration module on a memory resource associated with an information handling system is disclosed. The method also includes, prior to reconfiguring the memory resource, replicating the partition onto a second memory resource associated with the information handling system. The memory resource is then reconfigured. Next the partition is restored onto the memory resource using the partition replicated on the second memory resource.

The present disclosure includes a number of important technical advantages. One important technical advantage is providing a partition that includes a configuration module. The configuration module allows the partition to be replicated onto another memory resource and later restored, thereby preventing problems associated with losing the partition during reconfiguration of the memory resource. Additionally, because the configuration module makes the loss of the partition less likely, the functionality of the partition can be expanded such that additional utilities, such as system specific drivers, may be stored within the partition. Additional advantages will be apparent to those of skill in the art from the figures, description and claims provided herein.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 shows an information handling system according to teachings of the present disclosure;

FIG. 2 shows a flow diagram showing a method for managing a partition according to teachings of the present disclosure; and

FIG. 3 shows a flow diagram showing a method for updating utilities stored on a partition.

### DETAILED DESCRIPTION OF THE INVENTION

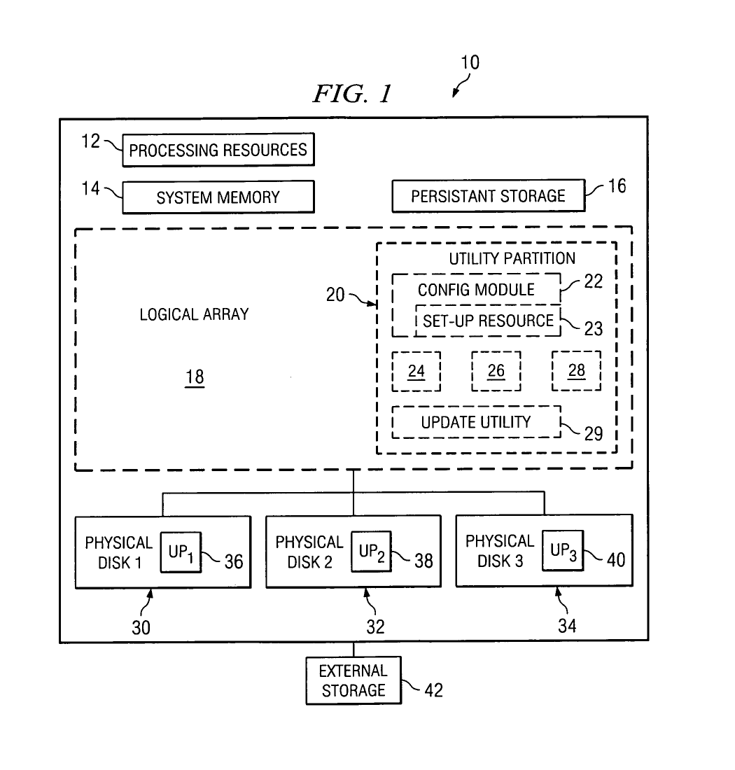

Preferred embodiments of the invention and its advantages are best understood by reference to FIGS. 1-3 wherein like numbers refer to like and corresponding parts and like element names to like and corresponding elements.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Now referring to FIG. 1, an information handling system, referred to generally at 10, is shown. Information handling system 10 includes processing resource 12, system memory 14, persistent memory 16 and logical storage array 18. Logical Storage array 18 may also be referred to as a logical array, a storage array or a memory resource. Additionally, external storage resource 42 may be in operable communication with information handling system 10. Processing resource 12 and system memory 14 may cooperate to allow the system to store, process and execute instructions as is well known to those of skill in the art.

Persistent memory 16 may be a nonvolatile random access memory (NVRAM) whose contents are saved when power to information handling system 10 is turned off. In an alternate embodiment, persistent memory 16 may comprise flash memory. In an alternate embodiment, persistent memory 16 may comprise any suitable nonvolatile storage whose contents are retained when system power is turn off.

In the present embodiment, logical array 18 is a logical representation of physical storage disks 30, 32 and 34. The present embodiment includes three physical disks 30, 32 and 34. Logical array 18 and physical disks 30, 32 and 34 may comprise a redundant array of independent disks (RAID). In alternate embodiments, array 18 may comprise more or fewer disks and be operable to support any suitable RAID standard.

Partition 20 is stored within logical array 18. Partition 20 may also be referred to as a system partition, a utility partition, a system or utility partition (SUP), an OEM partition or a hidden partition. In the present embodiment, partition 20 is a 32 MB partition, however, in alternate embodiments partition 20 may be of any suitable size. Additionally, in the present embodiment portions 36, 38 and 40 of utility partition 20 are distributed among physical disks 30, 32 and 34. In alternate embodiments utility partition 20 may be distributed within the physical disks 30, 32 and 34 associated with logical array 18 in any suitable manner.

Partition 20 includes a configuration module 22 as well as additional resources 24, 26 and 28. Configuration module 22 may also be referred to as a RAID configuration module. Configuration module 20 represents suitable software and executable instructions, as well as controlling logic, to provide the functions described herein. Configuration module 22 may include a set-up resource 23 operable to facilitate the configuration or reconfiguration of logical array 18 according to selected specifications. In the present embodiment, set-up utility 23 is embedded within configuration module 22, however, in alternate embodiments, set-up utility 23 may be provided within partition 20 as a separate or independent tool, utility or application.

Configuration module 22 is preferably utilized prior to any configuration or reconfiguration of partition 20. Prior to such a configuration, configuration module 22 replicates the partition 20 onto a second memory resource associated with information handling system 10. In the present embodiment, the second memory resource may be, for example, persistent storage 16 or external storage 42. The second memory resource may also be referred to as a “secondary” memory resource. It is also possible to store a copy of partition 20 on system memory 14. External storage 42 may be any suitable removable storage media such as a floppy disk, a CD, a DVD, a USB media or the like. In one embodiment, configuration module 22 may require user input (or permission) prior to copying partition 20 onto the second memory resource.

After configuration or reconfiguration of logical array 18, configuration module 22 restores partition 20 onto logical array 18 by copying the partition that has been temporarily stored onto the second memory resource. In this manner, following the reconfiguration of logical array 18, partition 20 will be restored and will again be available to users and technical support personnel.

In the present embodiment, partition 20 also includes utilities 24, 26 and 28. Utilities 24, 26 and 28 may comprise any suitable utility, application or tool desirable to provide via a partition. In the present embodiment, utility 24 comprises one or more diagnostic programs, utility 26 comprises a partition configuration set-up utility and utility 28 comprises one or more drivers that may be required by information handling system 10. For example, drivers 28 may comprise system specific drives such as device drivers, PNP drivers, network drivers and other drivers presented to the operating system for operation. Additionally, diagnostic utility 24 may comprise a system diagnostic, a memory diagnostic, a network diagnostic or another suitable diagnostic utility.

In the present embodiment, partition 20 further includes update utility 29. Update utility 29 preferably represents any suitable software or executable instructions, including controlling logic, that accomplishes or facilitates the functions listed herein. Update utility 29 may preferably determine whether an update or revision is available for one or more of the utilities stored within partition 20. If a revision is available, update utility 29 may then facilitate updating the utility for which an update is available. In one embodiment, update utility 29 may require user input (or permission) prior to determining whether updates exist and prior to updating any existing utilities. Update utility 29 may also determine whether new utilities, pertinent to information handling system 10, are available for inclusion within portion 10 and facilitate copying such new utilities to partition 20.

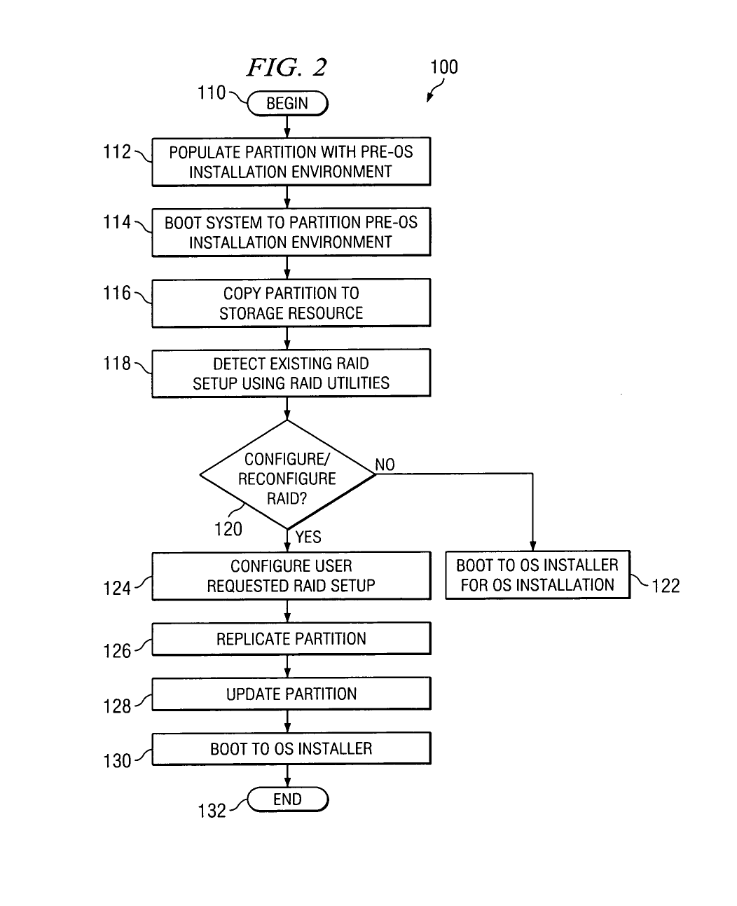

Now referring to FIG. 2, a method, indicated generally at 100, for managing a partition of a memory resource within an information handling system is disclosed. The method begins 110 with the population of the partition with a pre-operating system installation environment 112. Next, the method includes booting the information handling system to the pre-operating system environment stored within the partition 114. Next, the partition may be copied and stored on a secondary memory resource, such as a persistent memory resource or another suitable memory resource 116. In a preferred embodiment the copy of the partition may preferably be stored along with an INI file that stores the partition attributes such as size, file system type, etc. In one embodiment, the INI file (not expressly shown) may be text based file configured to facilite the restoration and rebuild operations described herein.

The next step includes detecting the existing configuration of the memory resource using the set-up resources 118. In the present embodiment the memory resource may comprise a RAID storage resource and the set-up resource may comprise a RAID set-up resource provided within the partition.

The next step is to determine whether to reconfigure the memory resource 120. In the event that no reconfiguration is requested, the system may be booted to an operating system installer in order to install the operating system 122. The operating system installer may be provided, for example, from a network resource or from an operating system CD or DVD.

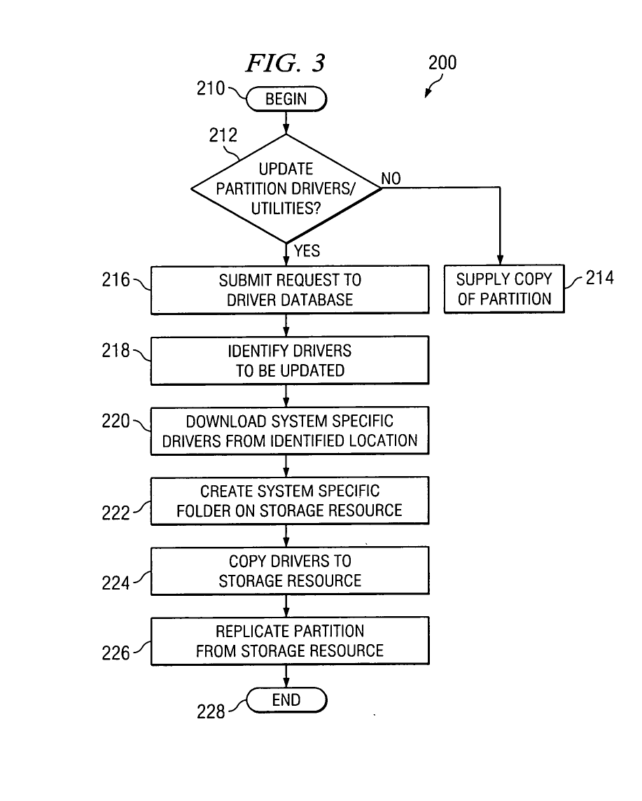

In the event that a reconfiguration of the memory resource is requested, the memory resource may preferably be reconfigured using a set-up utility provided within the partition 124. After the reconfiguration is complete, the partition is replicated or copied from the copy of the partition that had previously been stored (in step 116) and written to the partition 126. In a particular embodiment, step 126 may use the INI file in copying the partition stored on the second memory resource onto the logical array. Next, if desirable, the partition may be updated 128 as described in detail in FIG. 3, below. The system may then be booted to the operating system installer 130 thereby completing the method 132.

Now referring to FIG. 3, a method for updating a partition, indicated generally at 200, as shown. The method begins 210 by first determining whether to update utilities or drivers stored within the partition 212. In the event that an update is not requested or desired, the existing copy of the partition is used to load or write the partition onto the memory resource 214.

In the event that an update to the partition drivers and utilities is requested, first a request is submitted to a driver database (not expressly shown) 216. Next, the drivers that are to be updated are identified 218. System specific drivers (drivers that are required for a specific information handling system) or driver updates may then be downloaded from an identified location 220. Next, a system specific folder may preferably be created on the logical array 222 and copies of the desired drivers may be loaded onto the either the logical array or the second memory resource 224. Next, the partition is replicated from the second memory resource and written to the logical array 226, thereby ending the method 228.

Although the disclosed embodiments have been described in detail, it should be understood that various changes, substitutions and alterations can be made to the embodiments without departing from their spirit and scope.

What is claimed is:

1. An information handling system comprising:
a memory resource having a partition, the partition having at least one utility application stored thereon;
the partition having a set-up resource operable to configure the memory resource;
the partition also having a configuration module operable to:
replicate the partition onto a second memory resource associated with the information handling system; and
restore the partition on the memory resource from the partition replicated on the second memory after the configuration of the memory resource.

2. The information handling system of claim 1 wherein the at least one utility application comprises a diagnostic application.

3. The information handling system of claim 1 wherein the at least one utility application comprises a redundant array of independent disks (RAID) set up utility.

4. The information handling system of claim 1 wherein the at least one utility application comprises at least one driver.

5. The information handling system of claim 1 wherein the second memory resource comprises a persistent memory.

6. The information handling system of claim 1 wherein the second memory resource comprises a nonvolatile random access memory.

7. The information handling system of claim 1 wherein the second memory resource comprises a removable data storage medium.

8. The information handling system of claim 1 wherein the memory resource comprises a logical array, the logical array providing a logical representation of one or more physical storage disks.

9. The information handling system of claim 8 wherein at least one portion of the partition is stored on each of the one or more physical storage disks.

10. The information handling system of claim 1 wherein the memory resource comprises a redundant array of independent disks (RAID).

11. The information handling system of claim 1 comprising:
a plurality of utility applications; and
an update utility operable to:
determine whether an update is available for one or more of the plurality of utility applications; and
update at least one utility application for which an update is available.

12. The information handling system of claim 1 further comprising a system memory operable to store a copy of the configuration module during execution thereof.

13. A configuration module for a partition stored on an information handling system memory resource, the configuration module including executable instructions operable to:
replicate the partition onto a second memory resource associated with the information handling system;
configure the memory resource; and
restore the partition onto the memory resource from the partition replicated on the second memory.

14. The configuration module of claim 13 wherein the second memory resource comprises a persistent memory.

15. The information handling system of claim 13 wherein the second memory resource comprises a nonvolatile random access memory.

16. The information handling system of claim 13 wherein the second memory resource comprises a removable data storage medium.

17. The information handling system of claim 13 wherein the memory resource comprises a logical array, the logical array providing a logical representation of one or more physical storage disks.

18. A method for managing a partition stored on an information handling system comprising:
providing a configuration module on a memory resource associated with an information handling system;
prior to reconfiguring the memory resource, replicating the partition onto a second memory resource associated with the information handling system;
reconfiguring the memory resource; and
restoring the partition on the memory resource using the partition replicated on the second memory resource.

19. The method of claim 18 wherein the second memory resource comprises a persistent memory resource.

20. The method of claim 18 further comprising:
storing a plurality of utility applications on the partition;
determining whether an update is available for one or more of the plurality of utility applications; and
updating at least one utility application for which an update is available.
